(19) United States
(12) Patent Application Publication
(10) Pub. No.: US 2007/0096871 A1
(43) Pub. Date: May 3, 2007

(54) Visitor pass for devices or for networks

(76) Inventors: David M. Mason, Morgan Hill, CA (US); Joseph A. Curcio JR., Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/262,256

(22) Filed: Oct. 28, 2005

(51) Int. Cl. G05B 19/00

(52) U.S. Cl. 340/5.61; 340/5.7; 340/5.74

(57) ABSTRACT

In one embodiment of the invention, a method for providing security to a device, includes: reading a visitor pass to determine if the visitor pass is valid; if the visitor pass is invalid, then preventing access to a device by use of the visitor pass; and if the visitor pass is valid, then permitting access to the device by use of the visitor pass. If the visitor pass is valid, then access may also be permitted to a designated network by use of the visitor pass.

### TECHNICAL FIELD

Embodiments of the invention relate generally to computer systems, and more particularly to a visitor pass for devices such as computers or for networks.

### BACKGROUND

In current technology, if a visitor (e.g., a non-employee) to a company (or organization) needs to access a network, the visitor is typically provided a login name and a password associated to an employee of the company. Additionally, the visitor must be escorted to and from the company lobby in order to maintain security of the company premises. Providing a login name and password to the visitor permits the visitor with more access to, for example, the company's network than is typically necessary. In addition, the login name and password continues to be valid after the visitor has left or should have left the company premises. Therefore, there is a possibility that the visitor could intentionally or unintentionally utilize the login name and password to access the network at a later visit to the company premises.

In other settings such as, for example, the hotel industry, guests are required to sign-in at particular locations (e.g., the lobby) and may be required an escort in and out of the building. Typically, in hotels, a guest must sign in and provide a credit card before limited access to the hotel premises is permitted to the guest. However, computer networks in hotel premises may not provide sufficient security against unauthorized access by guests.

Therefore, the current technology is limited in its capabilities and suffers from at least the above constraints and deficiencies.

### SUMMARY OF EMBODIMENTS OF THE INVENTION

An embodiment of the invention provides a method for providing security to a device, including: reading a visitor pass to determine if the visitor pass is valid; if the visitor pass is invalid, then preventing access to a device by use of the visitor pass; and if the visitor pass is valid, then permitting access to the device by use of the visitor pass. If the visitor pass is valid, then access may also be permitted to a designated network by use of the visitor pass.

Another embodiment of the invention provides an apparatus for providing security to a device, including: a visitor pass configured to store a visitor pass code data. The apparatus also includes a visitor pass support module configured to read the visitor pass to determine if the visitor pass is valid. The visitor pass support module is configured to prevent access to the device by use of the visitor pass if the visitor pass is invalid, and to permit access to the device by use of the visitor pass if the visitor pass is valid.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an apparatus (system), in accordance with an embodiment of the invention.

FIG. 2 is a block diagram of an apparatus (system), in accordance with another embodiment of the invention.

FIG. 3 is a block diagram of an apparatus (system), in accordance with another embodiment of the invention.

FIG. 4 is a block diagram of an apparatus (system), in accordance with another embodiment of the invention.

FIG. 5 is a block diagram of an apparatus (system), in accordance with another embodiment of the invention.

FIG. 6 is a block diagram of an apparatus (system), in accordance with another embodiment of the invention.

FIG. 7 is a block diagram of an apparatus (system), in accordance with another embodiment of the invention.

FIG. 8 is a block diagram of an apparatus (system), in accordance with another embodiment of the invention.

FIG. 9 is a block diagram of a method, in accordance with another embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

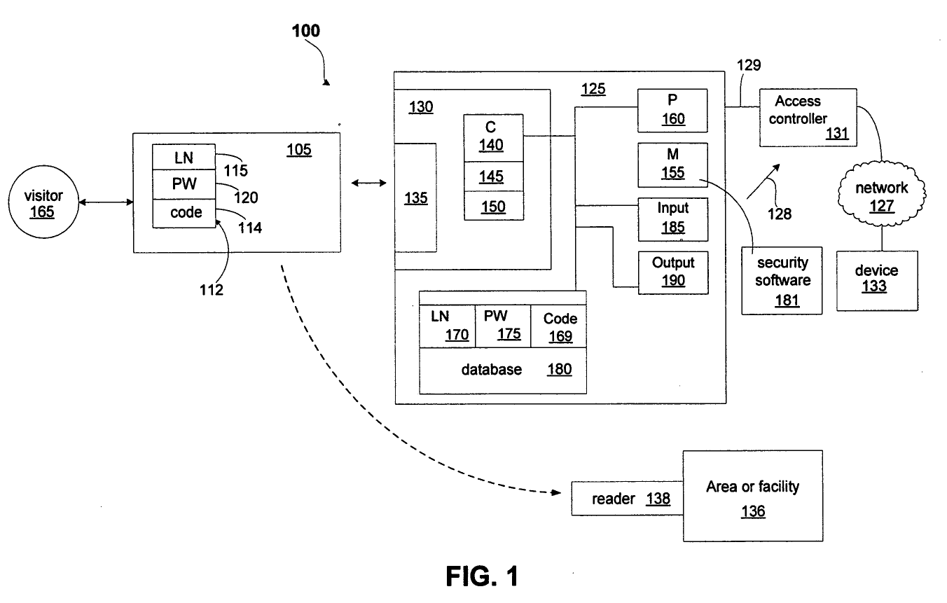

FIG. 1 is a block diagram of an apparatus (system) 100, in accordance with an embodiment of the invention. The apparatus 100 includes an embodiment of a visitor pass 105 that permits access to devices (e.g., a device 125 which may be a computer, server, security station, or other types of devices) or/and to designated network areas (e.g., a network 127 which may be a wide area network such as the Internet, a private area network such as a private local area network (private LAN), or other network area) if the visitor pass 105 is authenticated as valid as described in detail below.

Typically, the visitor pass 105 is implemented as a readable medium (e.g., an electronically-readable medium, optically-readable medium, or machine-readable medium). For example, the visitor pass 105 is implemented as a memory card which is readable by a data reader. However, the visitor pass 105 may be implemented by use of any suitable mechanism or medium that would be known to those skilled in the art, such as, for example, a smart card.

In an embodiment of the invention, the visitor pass 105 includes a memory 112 that stores a visitor pass code 114 and a login name 115 and a password 120, where the visitor pass code 114, the login name 115, and/or password 120 are used to authenticate the validity or invalidity of the visitor pass 105. The visitor pass code 114, login name 115, and password 120 are assigned to a particular visitor 165, so that the system 100 can recognize and determine if the particular visitor 165 is authorized to access a particular device or/and network area.

In another embodiment, the login name 115 and/or password 120 are not stored in the visitor pass 105, and instead, a visitor (user) 165 will manually input the login name 115 and/or password 120 into an input interface 185 (e.g., keyboard) of a device 125 after inserting the visitor pass 105 into the device 125.

In another embodiment of the invention, the login name 115 may be omitted or may not be used, and the validity or invalidity of the visitor pass 105 is instead determined by use of the visitor pass code 114 and the password 120.

A device 125 is configured to receive the visitor pass 105. The device 125 is typically a computer but may be another type of device. In the example of FIG. 1, the device 125 will be referred to as a computer 125. In one embodiment, the computer 125 includes a visitor pass support module 130 that reads and authenticates the validity of the visitor pass 105. Typically, the module 130 includes an interface 135 that receives and physically supports the visitor pass 105. As an example, the interface 135 is a socket or connector that permits communication between the elements in the visitor pass 105 and the elements in the computer 125. In another embodiment, the interface 135 is instead attached to a docking station (not shown in FIG. 1) instead of the computer 125, where the docking station is configured to support and function with a laptop or notebook computer. Other configurations may be used for placement of the module 130 and interface 135.

The module 130 also typically includes a controller 140 that detects a visitor pass 105 that is in contact or in communication with the interface 135. The controller 140 includes the appropriate logic for detecting and controlling the visitor pass 105. For example, the controller 140 includes a sensing logic 145 that detects the visitor pass 105 and a reader logic 150 that reads data stored in the visitor pass 105. For example, the data that is stored in and read from the visitor pass 105 includes the visitor pass code 114 and, optionally, the login name 115 and/or password 120. The reader logic 150 may be configured to read electronic data, to read optical data, and/or to read other types of data stored in the visitor pass 105. The module 130 can also include other elements or logic that permits reading of memory cards, smart cards, electronic media, optical media, or other data storage media.

The computer 125 also includes a memory 155 and a processor 160. The memory 155 stores various data and software, and the processor 160 executes the proper software/firmware in order to permit the computer 125 to perform various computing operations. The computer 125 also includes other conventional elements that are known to those skilled in art.

In an embodiment of the invention, when a visitor 165 inserts or connects the visitor pass 105 to the interface 135, the controller 140 compares the visitor pass code 114, login name 115, and password 120 in the visitor pass 105 to a stored pass code 169, a login name 170, and password 175 in a database 180, respectively, in order to authenticate the validity of the visitor pass 105. The database 180 may be in the memory 155 or may be in another memory device. As an example, standard memory address linking techniques may be used to associate a stored pass code 169 with a login name 170 and with a password 175 in the database 180, so that the controller 140 can compare the visitor pass code 114, login name 115, and password 120 combination with the stored pass code 169, login name 170 and password 175 combination in the database 180. Other known methods may be used to associate the stored pass code 169 with the login name 170 and with the password 175. The database 180 may store other stored pass codes 169, login names 170, and passwords 175 that are used to match the stored visitor pass codes, and stored login names and passwords in other visitor passes 105, so that the controller 140 can authenticate other visitor passes 105 with different visitor pass codes 114, different login names 115, and different passwords 120. When the controller 140 determines that the visitor pass code 114 in the visitor pass 105 matches a stored access code 169, and that an associated login name 115 matches a login name 170 stored in the database 180 and an associated password 120 matches a password 175 in the database 180, then the controller 140 in the module 130 will permit the visitor 165 to, for example, access and control the computer 125 via input devices 185 (e.g., keyboard, mouse, touch screen interface, and/or other devices) and to view the computer 125 output via output devices 190 (e.g., computer screen, speaker, and/or other devices), and to use the computer 125 and/or also access the network 127. On the other hand, when the controller 140 determines that the visitor pass code 114 in the visitor pass 105 does not match a stored access code 169 in the database 180, and the associated login name 115 does not match a login name 170 stored in the database 180 and/or the associated password 120 does not match a password 175 in the database 180, then the controller 140 will prevent the visitor 165 to, for example, access and control the computer 125 and to use the computer 125 and the network 127.

In another embodiment of the invention, the controller 140 is omitted if the processor 160 can perform the functions of the controller 140. For example, a security software program 181 (e.g., stored in memory 155 and executed by the processor 160) can read the stored data in the visitor pass 105 and can compare the data in the visitor pass 105 with the stored data in the database 180 in order to authenticate the visitor pass 105 and permit/prevent the visitor 165 to access/control the computer 125 and network 127, as previously described above. Other configurations can be implemented in FIG. 1 in order to achieve the various functionalities described in this disclosure.

When the visitor pass 105 is authenticated as valid by the controller 140, then the controller 140 will send an activation signal 128 via communication path 129 to an access controller 131, so that the access controller 131 is activated. When the access controller 131 is activated, the access controller will permit the computer 125 to communicate via the designated network 127. Therefore, the computer 125 will be able to communicate with any device 133 on the designated network 127. Also, the designated network may be a “visitor specific” network that has very limited resources (printers, low bandwidth WAN connections, etc.) for computer 125 to access. The access controller 127 is typically functionally integrated into the network 127. As an example, the device 133 is a server that supports a website or webpage that can be viewed by the computer 125. The device 133 may be other devices such as, for example, a database that can download data to the computer 125 or an electronic mail server that can send electronic mail content to the computer 125 or receive electronic mail content from the computer 125, or another type of device.

The communication path 129 may be a wired or wireless communication path. If the communication path 129 is a wireless path, then the computer 125 will typically include a transceiver and the network 127 will typically include elements for wireless transmission (e.g., antenna, transceiver, wireless access point, and/or other elements), with suitable devices incorporating any required protocols, hardware elements and/or software elements that are required by the particular communication scheme that is employed. As known to those skilled in the art, wireless methods may include, but are not limited to, spread-spectrum, wi-fi (wireless fidelity), Bluetooth wireless, or any other suitable wireless method. Transmission can be radio frequency, optical, infrared, microwave, or other signal types.

The visitor pass code 114, login name 115, and password 120 may be programmed into the visitor pass 105 by use of, for example, conventional memory write methods so that the visitor pass code 114, login name value 115, and password value 120 are written into memory spaces in the visitor pass 105. Conventional memory card data write techniques, for example, could also be used to write (or store) the visitor pass code 114, login name value 115, and password value 120 into the visitor pass 105 if the visitor pass 105 is implemented as a memory card. Other conventional data write methods may be used to program the visitor pass code 114, login name value 115, and password value 120 into the visitor pass 105.

In one example application, the visitor 165 can, for example, be a frequent customer or company employee from another site and can be provided a visitor pass 105 to access the secured devices, drives in the devices, and/or network areas.

In another example application, the visitor 165 can, for example, be a hotel guest or guest in another type of facility and can be provided the visitor pass 105 to access the secured devices, drives, and/or network areas.

The visitor pass 105 may also be used to permit access to a secured area or facility 136 which may be, for example, a hotel room, a hotel area such as exercise or recreation rooms, office areas, building facilities, and/or other secured areas. A reader 138 can read the visitor pass code 114, login name 115, and password 120 in the visitor pass 105 (or read only the visitor pass code 114 and password 120 if the login name 115 is not used for authentication). If the reader 138 determines that the visitor pass code 114, login name 115, and password 120 are valid, then the reader 138 can unlock the entrance of the secured area 136 so that the visitor 165 can access the secured area 136. As an example, if the visitor pass 105 is implemented as a memory card, then the reader 138 will include features for reading the memory card data.

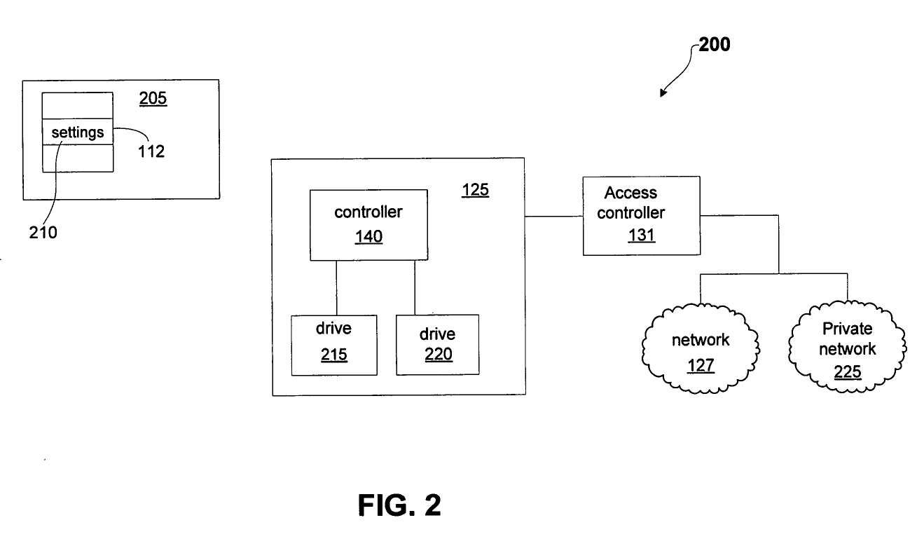

FIG. 2 is a block diagram of an apparatus (system) 200, in accordance with another embodiment of the invention. Note that the features in FIG. 2 may be combined with at least some of the features shown in the other drawing figures. A visitor pass 205 may be pre-stored with one or more settings (preferences) 210 in the memory 112. One example of the pre-stored settings 210 that are used in networks is commonly known as “favorites” which are Uniform Source Locator (URL) addresses that are recorded in a menu setting. The pre-stored settings 210 may be other types of configuration data.

When the controller 140 reads the pre-stored settings 210, the controller 140, for example, will permit the visitor to access a drive 215 and will prevent access to another drive 220 in the computer 125. Alternatively, the pre-stored settings 210 may permit other functionalities such as preventing access to both drives 215 and 220. Based on the pre-stored settings 210, the access controller 131, for example, will permit the visitor to access the network 127 and will prevent access to another network 225. As an example, the network 127 can be a wide area network such as the Internet and the private network 225 can be a private LAN, although the networks 127 and 225 can be other types of networks as well. The pre-stored settings 210 may permit other functions such as, for example, setting the commonly-accessed websites in the network 127 for the visitor or other operations.

In one application, the visitor can, for example, be a frequent customer, company employee from another site, hotel guest or other visitor, and can provide the visitor pass 205 to an authorized company personnel or hotel employee. The visitor pass 205 will then permit the visitor to access the authorized devices, drives, and/or network areas based upon the pre-stored settings 210 in the visitor pass 205.

In the above examples, the visitor pass 205 can also store a visitor pass code 114, login name 115, and/or password 120 that are required to be authenticated, so that the visitor pass 205 provides additional security to devices, drives, and/or network areas.

In the above examples, the visitor pass 205 can also be stored in a remote secured database on a visitor limited network. This could be a physically separated network or a VLAN isolated or secured tunneled data—any standard method that allows communications with a remote server, but is a limited network connection. After the visitor pass 205 is compared to the remote database information, the visitor will either be allowed or denied additional network privileges based on the comparison passing or failing respectively. As an example, when the visitor tries to access the network, the visitor is only given a verification-only access privileges until the visitor pass 205 data is compared to the remote data server (or remote secured database). Once the visitor pass 205 is approved, the network switches could be configured to allow the visitor more or additional access or privileges to the network in addition to the verification-only access privileges. As another example, assume that a visitor is given a temporary or visitor badge with an electronic tag (e.g., RFID tag). The specific tags can relate to the visitor pass data. An electronic tag reader (e.g., RFID reader) could trigger the visitor pass data to transmit to a remote server for a security check. As another example, the visitor is given a printed pass with remote data checks, in order to perform the security check.

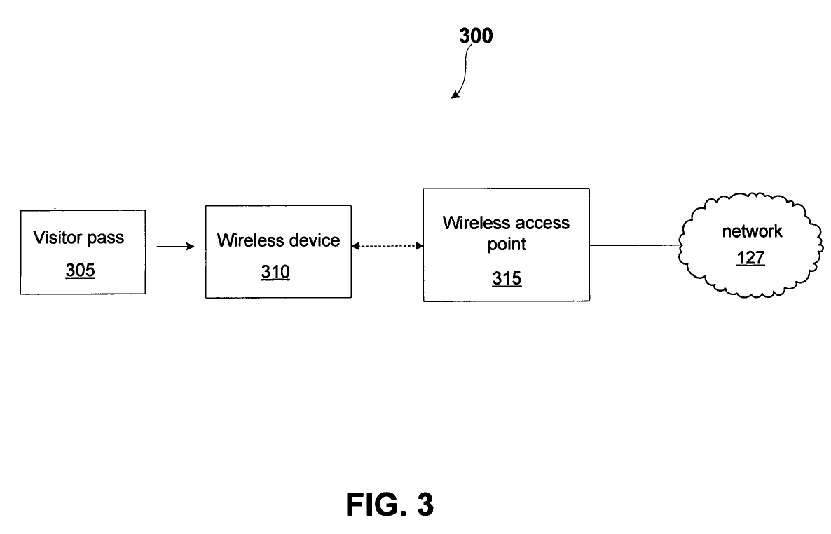

FIG. 3 is a block diagram of an apparatus (system) 300, in accordance with another embodiment of the invention. Note that the features in FIG. 3 may be combined with at least some of the features shown in the other drawing figures. A visitor pass 305 can be received by and authenticated by a wireless device 310. As an example, the wireless device 310 is a portable or handheld wireless computing device or wireless client adapter. If the wireless device 310 authenticates the visitor pass 305 as valid, then a visitor can access and use the network 127 via a wireless access point 315. It is within the scope of embodiments of the invention that other types of nodes can be used for accessing the network 127 instead of a wireless access point, as wireless communication technology improves. The visitor can use the wireless device 310 in order to, for example, send and receive communications along the network 127. Note that the network 127 can include wireless network paths/elements, wired network paths/elements, or a combination of wireless and wired network paths/elements.

As known to those skilled in the art, a wireless access point (WAP) is a device that connects wireless communication devices together to create a wireless network. A WAP is usually connected to a wired network, and can relay the transmitted communication data. Many WAPs can be connected together to create a larger network that allows the roaming functionality. The range of WAPs can also be extended through the use of repeaters and reflectors, which can bounce or amplify the wireless signals.

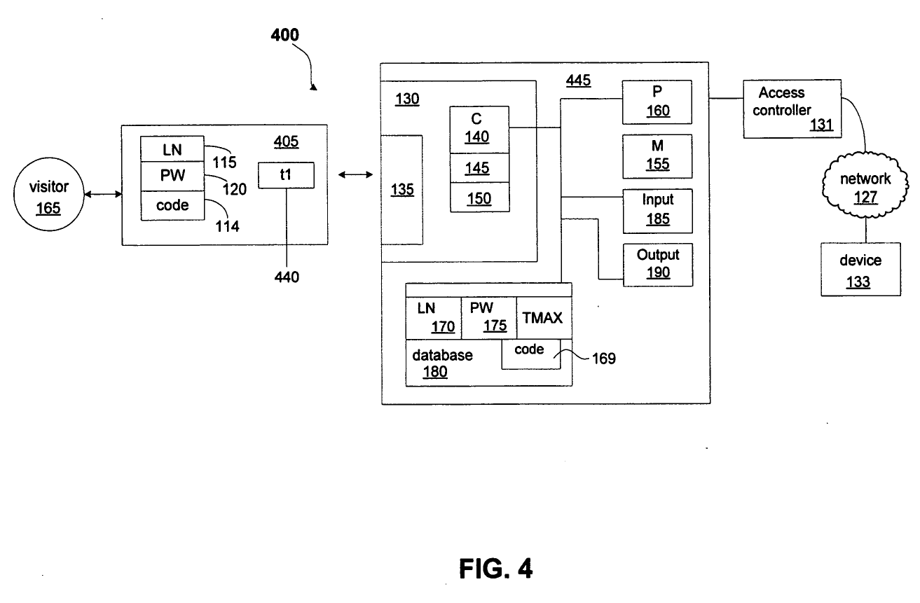

FIG. 4 is a block diagram of an apparatus (system) 400, in accordance with another embodiment of the invention. Note that the features in FIG. 4 may be combined with at least some of the features shown in the other drawing figures. This embodiment provides a visitor pass 405 where the visitor pass code 114, associated login name 115, and associated password 120 would only be valid for a limited time frame. The visitor pass 405 includes a timekeeper 440 (e.g., clock) that holds a timevalue t1. The timevalue t1 would typically include a date value (e.g., day, month, and year) and a time value (e.g., minute and hour).

The controller 140 compares the visitor pass code 114, login name 115, and password 120 to a stored code 169, login name 170, and password 175, respectively, and also compares the timevalue t1 in the visitor pass 405 to a threshold timevalue TMAX in the database 180, in order to authenticate the visitor pass 405 as valid or invalid. The threshold timevalue TMAX would typically include a date value (e.g., day, month, and year) and a time value (e.g., minute and hour). In an embodiment of the invention, if the timevalue t1 in the visitor pass 405 is later than the threshold timevalue TMAX, then the visitor 165 will not be able to use the visitor pass 405 in order to access and use the computer 445 and the network 127.

As an example, if the threshold timevalue TMAX is set at 5 PM of the current day/month/year, then a visitor 165 will not be able to access the computer 445 in a company facility after 5 PM. As another example, if the threshold timevalue TMAX is set at 12 PM of the following day, then a visitor 165 will not be able to access the computer 445 in a hotel room after 12 PM of the following day, since the visitor 165 may be required to check out of the hotel by that particular time of the following day.

The visitor pass code 114, and associated login name 115 and associated password 120 can be reactivated by changing the threshold timevalue TMAX in the database 180. For example, assume that the threshold timevalue TMAX in the database 180 is set at 12 AM on Jan. 1, 2006. Therefore, the login name 115 and password 120 will become invalid after 12 AM on Jan. 1, 2006. If the threshold timevalue TMAX in the database 180 is then changed by an administrator of the computer 445 to 12 AM on Jan. 2, 2006, then the visitor 165 will be able to use the visitor pass 405 to access and use the computer 445 (and network 127) until 12 AM on Jan. 2, 2006. The administrator can set the threshold timevalue TMAX to other values.

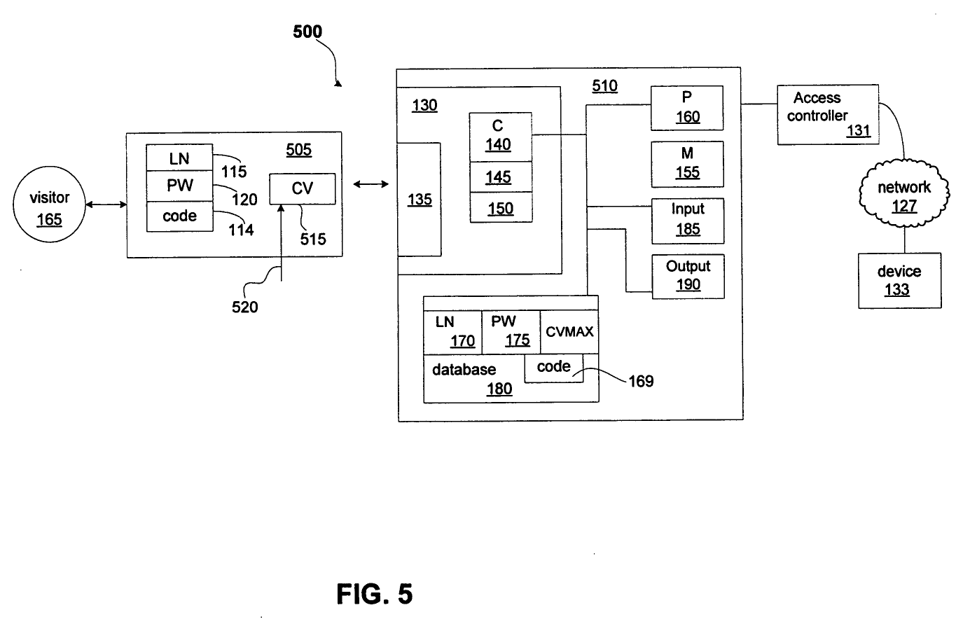

FIG. 5 is a block diagram of an apparatus (system) 500, in accordance with another embodiment of the invention. Note that the features in FIG. 5 may be combined with at least some of the features shown in the other drawing figures. This embodiment provides a visitor pass 505 where the visitor pass code 114, and associated login name 115 and associated password 120 would only be valid if the number of access (i.e., the number of use) by the visitor pass 505 to a computer 510 does not exceed a threshold number. The visitor pass 505 includes a counter stage 515 that holds a counter value CV which is incremented for each time that the visitor pass 505 is used to access the computer 510. The counter stage 515 may include logic that increments the CV value whenever the controller 140 reads the visitor pass code 114, login name 115, and/or password 120. Alternatively or additionally, the counter stage 515 may include a mechanism that increments the CV value whenever the visitor pass 505 is inserted into or connected to the interface 135. Alternatively, other methods may be used to increment the counter value CV whenever the visitor pass 505 is used to attempt to access the computer 510.

The controller 140 compares the visitor pass code 114, associated login name 115, and associated password 120 to a stored code 169, login name 170, and password 175, respectively, and also compares the counter value CV in the visitor pass 505 to a threshold counter value CVMAX in the database 180, in order to authenticate the visitor pass 505 as valid or invalid. The threshold counter value CVMAX would be a value that is set by an administrator of the computer 505. In an embodiment of the invention, if the counter value CV in the visitor pass 505 has exceeded the threshold counter value CVMAX in the database 180, then the visitor 165 will not be able to use the visitor pass 505 in order to access and use the computer 510 and the network 127. On the other hand, if the counter value CV in the visitor pass 505 has not exceeded the threshold counter value CVMAX in the database 180, then the visitor 165 will be able to use the visitor pass 505 in order to access and use the computer 510 and the network 127.

As an example, if the counter value CV is at 11 and the threshold counter value CVMAX is set at 10, then a visitor 165 will not be able to access and use the computer 510 by use of the visitor pass 505. On the other hand, if the counter value CV is at 9 and the threshold counter value CVMAX is set at 10, then a visitor 165 will be able to access and use the computer 510 and the network 127 by use of the visitor pass 505.

The visitor pass code 114, associated login name 115, and associated password 120 can be reactivated by changing the counter value CV in the visitor pass 505 and/or by changing the threshold counter value CVMAX in the database 180. The counter stage 515 decreases the counter value CV or resets the counter value CV to a value of “0”. For example, the counter stage 515 has an interface to receive a reset signal 520 which may be received via a phone line or network line from an administrative computer or other device. Alternatively or additionally, the counter stage 515 has an interface to receive a reset signal 520 which may be a code that is input into the interface. Alternatively or additionally, other methods may be used to decrease or reset the counter value CV, so that the authentication data (login name 115 and/or password 120) becomes valid. By decreasing the counter value CV in the visitor pass 505 and/or by increasing the threshold counter value CVMAX in the database 180, the visitor 165 can use the visitor pass 505 for additional accesses to the computer 510.

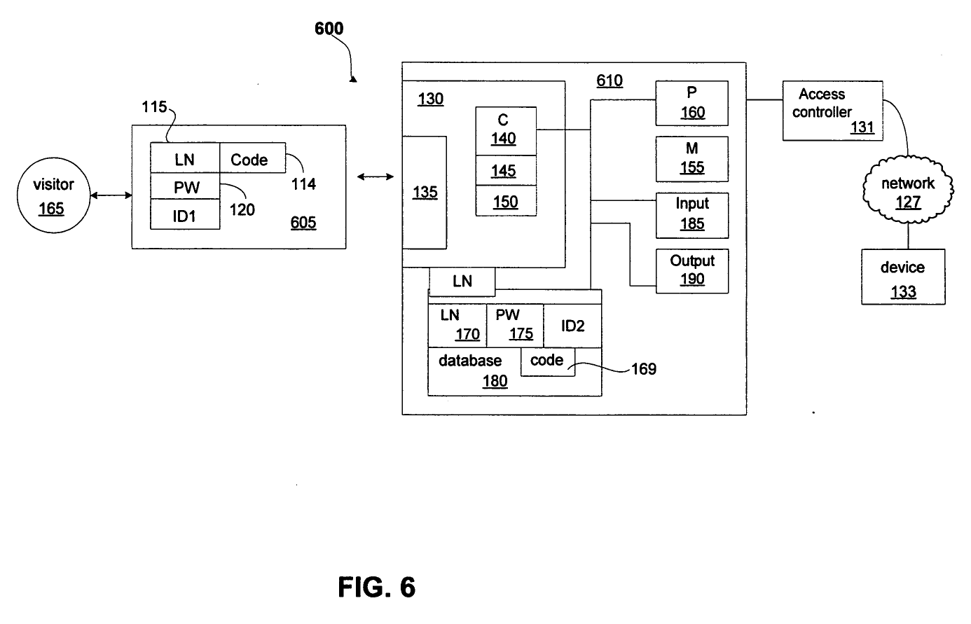

FIG. 6 is a block diagram of an apparatus (system) 600, in accordance with another embodiment of the invention. Note that the features in FIG. 6 may be combined with at least some of the features shown in the other drawing figures. This embodiment provides a visitor pass 605 with a feature where the visitor pass code 114, associated login name 115, and associated password 120 would only be valid if the visitor pass 605 stores a computer identifier value ID1 that matches a computer identifier value ID2 of the computer 610. The computer identifier value ID2 is, for example, the computer device ID name of the computer 610, a port identifier of the computer 610, computer MAC (Media Access Control) address, computer IP (Internet Protocol) or guest IP address or other identifier data that identifies the computer 610. The computer identifier value ID2 is typically stored in a memory or port of the computer 610 or may be stored in the database 180 or other memory locations.

The controller 140 compares the visitor pass code 114, associated login name 115, and associated password 120 to a stored code 169, login name 170, and password 175, respectively, and also compares the identifier ID1 in the visitor pass 605 to the computer identifier ID2 in the computer 610, in order to authenticate the visitor pass 605 as valid or invalid. In an embodiment of the invention, if the identifier ID1 in the visitor pass 605 does not match the computer identifier ID2 in the computer 610 (and even if there is a match between the codes 114 and 169, a match between the login names 115 and 170, and a match between the passwords 120 and 175), then the visitor 165 will not be able to use the visitor pass 605 in order to access and use the computer 610 and the network 127. On the other hand, if the identifier ID1 in the visitor pass 605 matches the computer identifier ID2 in the computer 610 (and if there is a match between the codes 114 and 169, a match between the login names 115 and 170, and a match between the passwords 120 and 175), then the visitor 165 will be able to use the visitor pass 605 in order to access and use the computer 610 and the network 127. Therefore, the visitor pass 605 is used to limit the access of a visitor 165 only to a particular computer or device as determined by the stored identifier ID1 in the visitor pass 605.

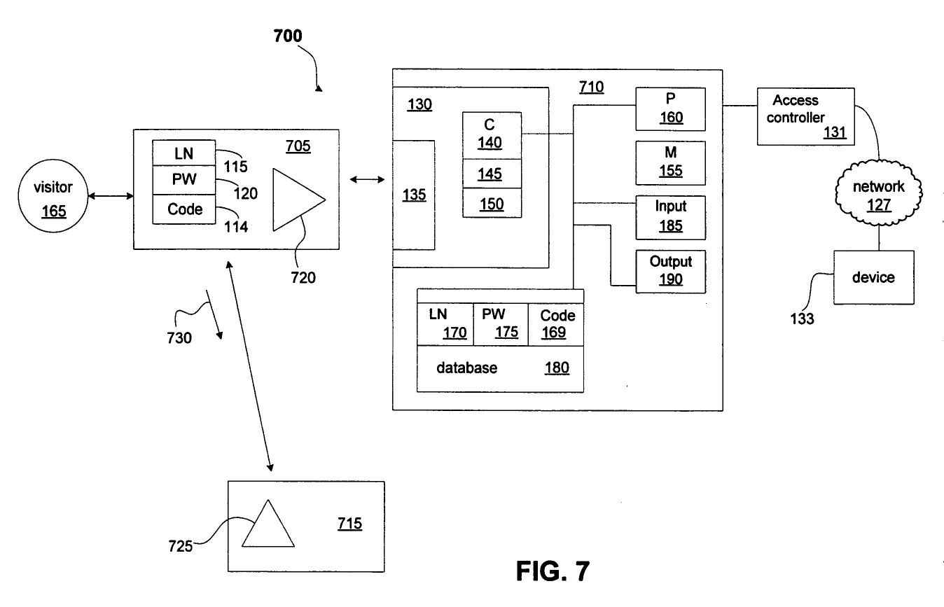

FIG. 7 is a block diagram of an apparatus (system) 700, in accordance with another embodiment of the invention. Note that the features in FIG. 7 may be combined with at least some of the features shown in the other drawing figures. This embodiment provides a visitor pass 705 with a location tracking feature so that the location of a visitor 165 (in possession of the visitor pass 705) can be tracked by a computing device such as, for example, a computer 715. The visitor pass 705 would include a location indicator 720 that is detectable by a location tracker 725 in the computer 715. As a result, the location tracker 725 can determine and indicate the location of the visitor pass 705 in a facility. As an example, the location indicator 720 is a transmitter and the location tracker 725 is a receiver, where the location indicator 720 would transmit a signal 730 that indicates the location of the location indicator 720 and the location tracker 725 can receive and process the signal 730 to learn about the location of the location indicator 720. As another example, the location indicator 720 and the location tracker 725 can be elements in a standard global positioning system (GPS), so that the location indicator 720 can indicate to the location tracker 725 about the position of the visitor pass 705. Alternatively, other known location tracking systems can be used to permit tracking of the location of the visitor pass 705.

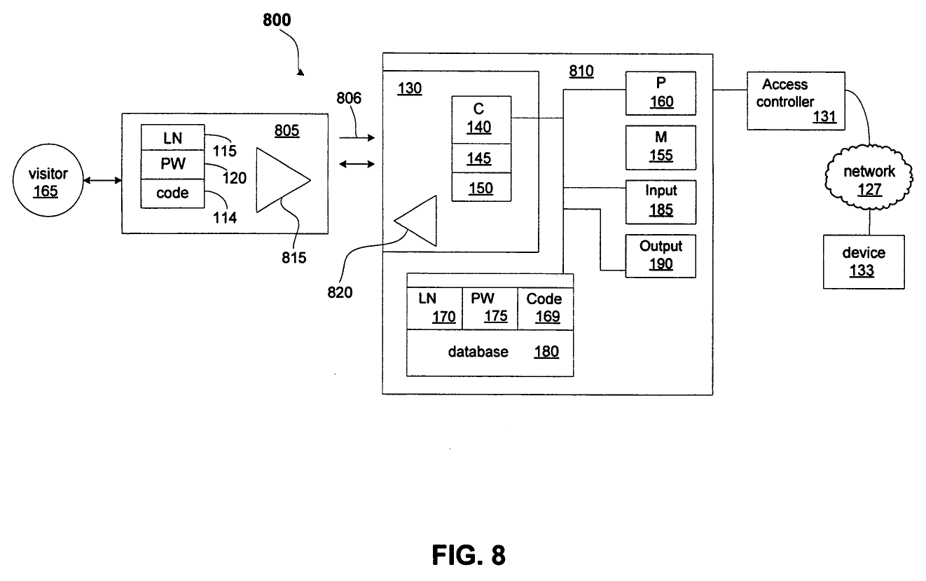

FIG. 8 is a block diagram of an apparatus (system) 800, in accordance with another embodiment of the invention. Note that the features in FIG. 8 may be combined with at least some of the features shown in the other drawing figures. This embodiment provides a visitor pass 805 that sends a wireless transmission 806 that could be received and processed by a computer 810. The visitor pass 805 includes a transmitter 815 that transmits the visitor pass code 114, and optionally, the associated login name 115 and associated password 120 (via wireless transmission 806) to a receiver 820 in a visitor pass support module 830. The controller 140 can then read the transmitted visitor pass code 114, login name 115, and password 120. Therefore, in this embodiment of the invention, the visitor pass 805 is not required to be physically connected to the computer 810 in order for the controller 140 to authenticate the visitor pass 805.

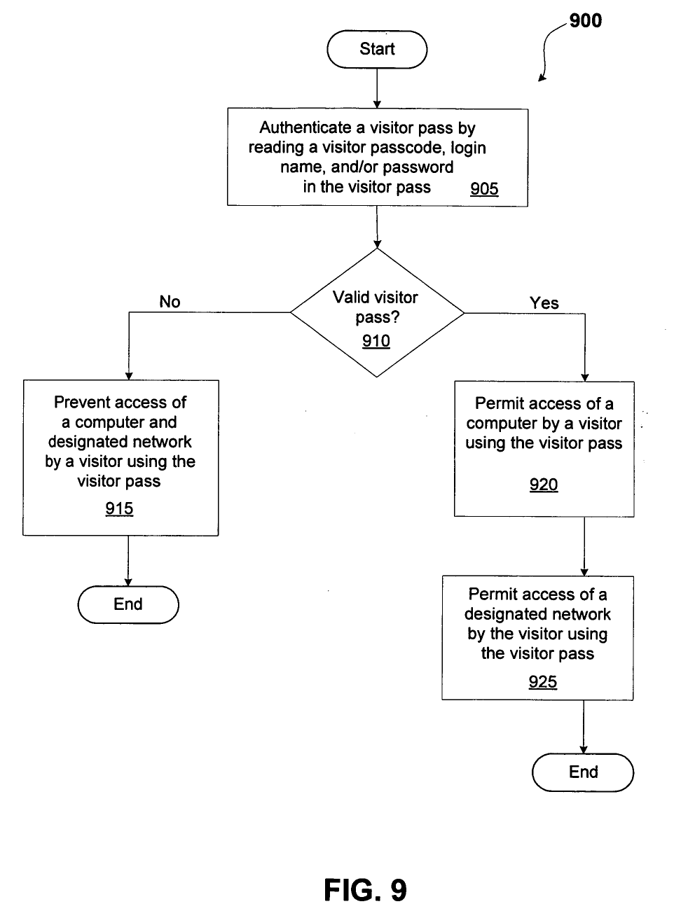

FIG. 9 is a block diagram of a method 900 for providing security to a device, in accordance with another embodiment of the invention. In block 905, a visitor pass is authenticated by reading authentication data (e.g., visitor pass code 114, login name and/or password) in the visitor pass. In an alternative embodiment, the visitor pass only stores the visitor pass code 114, and the visitor 165 will be required to manually provide or verbally provide the login name and/or password. Other data could also be read in the visitor pass, such as, for example, a time value t1, a device identifier ID1, or a counter value CV in the visitor pass.

In block 910, the validity or invalidity of the visitor pass is determined based upon the authentication of the visitor pass in block 905.

If the visitor pass is invalid, then in block 915, a visitor is prevented from accessing a computer (or other device) and is prevented from accessing a designated network by use of the visitor pass.

If the visitor pass is valid, then in block 920, the visitor is permitted to access the computer (or other device) by use of the visitor pass.

If the visitor pass is valid, then in block 925, the visitor is also permitted to access a designated network by use of the visitor pass.

Various elements in the drawings may be implemented in hardware, software, firmware, or a combination thereof.

It is also within the scope of an embodiment of the present invention to implement a program or code that can be stored in a machine-readable medium to permit a computer to perform any of the methods described above.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for providing security to a device, the method comprising:
reading a visitor pass to determine if the visitor pass is valid;
if the visitor pass is invalid, then preventing access to a device by use of the visitor pass; and
if the visitor pass is valid, then permitting access to the device by use of the visitor pass.

2. The method of claim 1, further comprising:
if the visitor pass is valid, then permitting access to a designated network by use of the visitor pass.

3. The method of claim 1, wherein the visitor pass comprises a readable medium.

4. The method of claim 1, wherein the device comprises a computer.

5. The method of claim 1, wherein the device comprises a wireless device.

6. The method of claim 5, further comprising:
accessing a network by use of the wireless device.

7. The method of claim 1, further comprising:
comparing at least one of a visitor pass code, login name, password, computer ID, time limits, location limits, number of use limits in the visitor pass stored within a remote secured database.

8. The method of claim 1, further comprising:
comparing a visitor pass code in the visitor pass with a stored pass code in the device.

9. The method of claim 1, further comprising:
comparing a login name with a stored login name in the device.

10. The method of claim 1, further comprising:
comparing a password with a stored password in the device.

11. The method of claim 1, further comprising:
permitting access to a facility by use of the visitor pass.

12. The method of claim 1, wherein the visitor pass includes visitor pass code data that is valid for a limited time frame.

13. The method of claim 1, wherein the visitor pass includes visitor pass code data that is valid based on a number of use of the visitor pass.

14. The method of claim 1, further comprising:
reactivating a visitor pass code data in the visitor pass, where the authentication data has been previously invalidated.

15. The method of claim 1, wherein authenticating the visitor pass further comprises:
comparing an identifier in the visitor pass with a stored identifier in the device.

16. The method of claim 1, further comprising:
tracking a location of the visitor pass.

17. The method of claim 1, further comprising:
communicating, by the visitor pass, with the device by wireless transmission.

18. The method of claim 1, further comprising:
storing a preference in the visitor pass; and
reading the stored preference, in order to configure the device or a network.

19. An apparatus for providing security to a device, the apparatus comprising:
a visitor pass configured to store a visitor pass code data that determines if the visitor pass is valid.

20. The apparatus of claim 19, further comprising:
a visitor pass support module configured to read the visitor pass and to determine if the visitor pass is valid.

21. The apparatus of claim 20, wherein the visitor pass support module is configured to prevent access to the device by use of the visitor pass if the visitor pass is invalid, and to permit access to the device by use of the visitor pass if the visitor pass is valid.

22. The apparatus of claim 20 wherein the visitor pass support module is configured to permit access to a designated network by use of the visitor pass if the visitor pass is valid.

23. The apparatus of claim 20, wherein the visitor pass support module is configured to permit access to a designated network with limited access, and upon validation of the visitor pass, configured to increase the access rights and resources to a different level.

24. The apparatus of claim 20, wherein the visitor pass support module is configured to authenticate the visitor pass by comparing a login name with a stored login name in the device.

25. The apparatus of claim 20, wherein the visitor pass support module is configured to authenticate the visitor pass by comparing a password with a stored password in the device.

26. The apparatus of claim 20, wherein the visitor pass support module is configured to authenticate the visitor pass by comparing a visitor pass code in the visitor pass with a stored code in the device or a remote device.

27. The apparatus of claim 19, wherein the visitor pass comprises a readable medium.

28. The apparatus of claim 19, wherein the device comprises a computer.

29. The apparatus of claim 19, wherein the device comprises a wireless device.

30. The apparatus of claim 19, wherein the visitor pass permits access to a facility.

31. The apparatus of claim 19, wherein the visitor pass includes data that is valid for a limited time frame.

32. The apparatus of claim 19, wherein the visitor pass includes authentication data that is valid based on a number of use of the visitor pass.

33. The apparatus of claim 20, wherein the wherein the visitor pass support module is configured to authenticate the visitor pass by comparing an identifier in the visitor pass with a stored identifier in the device.

34. The apparatus of claim 19, wherein the visitor pass is configured to store preferences and wherein the preferences are used in order to configure a device or a network.

35. An apparatus for providing security to a device, the apparatus comprising:
means for reading a visitor pass to determine if the visitor pass is valid;
means for preventing access to a device by use of the visitor pass, if the visitor pass is invalid; and
means for permitting access to the device by use of the visitor pass, if the visitor pass is valid.

36. An article of manufacture, comprising:
a machine-readable medium having stored thereon instructions to:
determine if the visitor pass is valid after the visitor pass is read;
if the visitor pass is invalid, then prevent access to a device by use of the visitor pass; and
1 if the visitor pass is valid, then permit access to the device by use of the visitor pass.
